(19) United States
(12) Patent Application Publication
(10) Pub. No.: US 2014/0268894 A1
(43) Pub. Date: Sep. 18, 2014

(54) DC-DC CONVERTER

(71) Applicant: KABUSHIKI KAISHA TOSHIBA, Minato-ku (JP)

(72) Inventors: Naoto SHINOHARA, Yokohama-shi (JP); Kazunobu NAGAI, Yokohama-shi (JP)

(73) Assignee: KABUSHIKI KAISHA TOSHIBA, Minato-ku (JP)

(21) Appl. No.: 14/027,566

(22) Filed: Sep. 16, 2013

(30) Foreign Application Priority Data
Mar. 14, 2013 (JP) 2013-051723

(51) Int. Cl. H02M 3/337

(52) U.S. Cl. CPC H02M 3/3376
USPC 363/17

(57) ABSTRACT

A DC-DC converter includes smoothing capacitors, switching circuits and capacitor circuits at a primary-side and a secondary-side of a high frequency transformer respectively. When a midpoint voltage of the capacitor circuit is detected by a voltage detection unit, a timing signal output unit is configured to supply to a drive circuit a timing signal according to a switching operation carried out by the primary-side or secondary-side switching circuit, in synchronization with a period in which a winding voltage of the high frequency transformer changes, based on a change in the midpoint voltage.

### CROSS-REFERENCE TO RELATED APPLICATIONS

This application is based upon and claims the benefit of priority from the prior Japanese Patent Application No. 2013-051723 filed on Mar. 14, 2013, the entire contents of which are incorporated herein by reference.

### FIELD

Embodiments described herein relate to a resonant DC-DC converter.

### BACKGROUND

DC-DC converters are used when a lithium-ion battery serving as a drive power source of an electric vehicle or the like and when electric power generated by a photovoltaic cell is converted for use, for example. These DC-DC converters have a general technical problem of improving power source efficiency by reduction in power loss.

In order that resonant DC-DC converters may be controlled so that a DC voltage V₀ supplied to a secondary-side load is constant, a control circuit is required to monitor the voltage V₀ to change a duty cycle or frequency of PWM signals supplied to switching elements. However, this control manner cannot carryout switching fixed to a 50% duty cycle at which a desirable efficiency can be achieved, with the result that power loss is increased. This leads to reduction in the power supply efficiency.

### BRIEF DESCRIPTION OF THE DRAWINGS

FIG. 1 is a block diagram showing an electrical arrangement of a resonant DC-DC converter according to a first embodiment;

FIG. 2-A to 2-H are operation timing charts;

FIG. 3 is a view similar to FIG. 1, showing a second embodiment;

FIG. 4 is a view similar to FIG. 1, showing a third embodiment;

FIG. 5-A to 5-E are views similar to FIGS. 2A-2H, showing the third embodiment;

FIGS. 6A to 6D are timing charts showing operations of a power regulating circuit and MCU;

FIG. 7 is a view similar to FIG. 1, showing a fourth embodiment;

FIG. 8 illustrates a circuit and block diagram showing an electrical arrangement of a starting circuit; and

FIGS. 9A and 9B are truth value tables showing logic of the starting circuit.

### DETAILED DESCRIPTION

In general, according to one embodiment, a DC-DC converter includes a primary-side smoothing capacitor connected in parallel to a primary-side DC power source, a primary-side switching circuit including two series connected switching elements and connected in parallel to the DC power source, and a primary-side capacitor circuit including two series connected capacitors and connected in parallel to the DC power source. A secondary-side smoothing capacitor is connected in parallel to a secondary-side load. A secondary-side switching circuit includes two series connected switching elements and is connected in parallel to the load. A secondary-side capacitor circuit includes two series connected capacitors and is connected in parallel to the load. The DC-DC converter further includes a high frequency transformer including a primary-side winding and a secondary-side winding. The primary-side winding is connected to a common connection point of the primary-side switching circuit and a common connection point of the primary-side capacitor circuit. The secondary-side winding is connected to a common connection point of the secondary-side switching circuit and a common connection point of the secondary-side capacitor circuit. A voltage detection unit is configured to detect a midpoint voltage of the primary-side or secondary-side capacitor circuit. A drive circuit is configured to supply a drive signal to the switching elements of the primary-side or secondary-side circuit. A timing signal output unit is configured to generate and supply to the drive circuit a timing signal according to a switching operation carried out by the primary-side or secondary-side switching circuit. The timing signal is in synchronization with a period in which a winding voltage of the high frequency transformer changes. The timing signal output unit generates the timing signal based on a change in the midpoint voltage.

Several embodiments will be described with reference to the accompanying drawings. Referring to FIGS. 1 and 2, a resonant DC-DC converter according to a first embodiment is shown. The DC-DC converter 1 includes an input terminal 2a (positive side) and an input terminal 2b (negative side). A DC power source 3 is connected between the input terminals 2a and 2b. The DC power source 3 may be a battery, an AC-DC converter/rectifier circuit, a solar cell or the like. Between the input terminals 2a and 2b are further connected a smoothing capacitor 4, a series circuit (a switching circuit 5) of two switching elements (N-channel MOSFETs, for example) 5a and 5b and a series circuit (a capacitor circuit 6) of two capacitors 6a and 6b. A high frequency transformer 7 has a primary-side winding 7P connected between common connection points of the series circuits.

The DC-DC converter 1 includes two output terminals 12a (positive side) and 12b (negative side) between which a load 13 designated by a symbol of DC power source is connected. The load 13 may be a battery, a resistance load, an inverter device driving an inductive load such as an electric motor, or the like. Furthermore, between the output terminals 12a and 12b are connected a smoothing capacitor 14, a series circuit (a switching circuit 15) of two switching elements 15a and 15b and a series circuit (a capacitor circuit 16) of two capacitors 16a and 16b. The high frequency transformer 7 includes a secondary-side winding 7S connected between common connection points of the series circuits.

Parasitic diodes 17a, 17b, 18a and 18b are connected between drains and sources (conduction terminals) of the switching elements 5a, 5b, 15a and 15b respectively. The switching elements may be bipolar transistors or IGBTs. In the case where the bipolar transistors are used, external free wheel diodes are provided, instead of the parasitic diodes. Furthermore, the type and the number of switching elements are not especially limited.

A voltage detection section (a voltage detection unit) 21 has an input terminal connected to a midpoint between the capacitors 6a and 6b to detect voltage at the midpoint with the ground serving as a reference. The detected voltage is supplied via a drive signal generation circuit (a timing signal output unit) 22 to a switching element drive circuit 23. The switching element drive circuit 23 generates a drive signal based on the supplied voltage signal to supply the drive signal to gates (conduction control terminals) of the switching elements 5a and 5b. In this case, in order that the switching elements may be prevented from forming a period in which both switching elements 5a and 5b are simultaneously turned on, the switching element drive circuit 23 sets a dead time that is a period in which both switching elements 5a and 5b are simultaneously turned off. However, the foregoing configuration is not restrictive when the switching element 5 is driven by a control unit having a dead time generation unit such as a microcomputer, for example. Furthermore, the switching element drive circuit 23 also supplies a drive signal via an insulation circuit 24 such as a photocoupler to gates of the secondary-side switching elements 15a and 15b.

The operation of the DC-DC converter will now be described with reference to FIG. 2 as well as FIG. 1. When the paired input-side switching elements 5a and 5b are alternately turned on and off, electrical current is caused to flow into a primary-side winding 7P of the high frequency transformer 7 at a resonant frequency depending upon capacitance of the capacitors 6a and 6b and inductance of the primary-side winding 7P. In this case, variations in the output-side load result in changes in an input impedance of the input-side (primary-side) circuit and a mutual inductance of the high frequency transformer 7, so that the resonant frequency does not become constant.

The switching elements 5a and 5b are turned on and off on the basis of a midpoint voltage VC between the parallel connected capacitors 6a and 6b. For example, when the switching element 5b is turned on at the time of system start-up, the capacitor 6a connected to the positive side of the DC power source 3 is fully charged. Subsequently, the switching element 5b is turned on so that resonance starts. More specifically, the midpoint voltage VC fluctuates in a range between voltage V+ of the DC power source 3 and reversed-polarity voltage −V+ according to on-off action of the switching elements 5a and 5b, as shown in FIG. 2-A to 2-D. For example, in a period when the switching element 5a is turned on, the midpoint voltage VC fluctuates in a sinusoidal waveform at the time depending upon the above-mentioned capacitance and inductance in a range in which amplitude polarity is positive. On the other hand, in a period when the switching element 5b is turned on, the midpoint voltage VC fluctuates in a sinusoidal waveform in a range in which amplitude polarity is negative.

In this case, the midpoint voltage waveform between the capacitors 6a and 6b delays 90° in phase relative to a waveform of current IL1 flowing to the primary side of the high frequency transformer 7 as shown in FIG. 2-F. Accordingly, the voltage detection section 21 is provided with a hysteresis characteristic in consideration of subsequent circuit delay time. The midpoint voltage is compared with a threshold voltage by a comparator or the like, so that a control loop is formed in which gate drive signals for the switching elements 5a and 5b are generated in synchronization with reach of the midpoint voltage in the vicinity of −V+ or V+ (see third embodiment). A comparator may be for use with a bipolar or monopolar power source. Regarding the negative side, an input voltage may be level-shifted and then compared. More specifically, when the amplitude of output signal of the drive signal generation circuit 22 is approximate to a positive maximum value V+, the switching element drive circuit 23 turns off the switching element 5b and turns on the switching element 5b after lapse of the dead time. Furthermore, when the voltage amplitude is approximate to a negative side maximum value −V+, the switching element drive circuit 23 turns off the switching element 5a and subsequently turns off the switching element 5a after lapse of the dead time. A gate drive signal is thus generated and supplied (see FIG. 2-C and 2-D). As a result, the switching circuit 5 is switched by a PWM signal of a substantially 50% duty cycle inclusive of the dead time.

As the result of the above-described arrangement, soft switching can be realized while the resonant frequency depending upon the capacitors 6a and 6b and the high frequency transformer 7 is maintained.

The following describes the operation of the switching elements 15a and 15b composing the output-side (secondary-side) circuit of the DC-DC converter 1. Diodes 18a and 18b are connected in parallel to each other. Accordingly, AC output of the secondary-side winding 7S of the high frequency transformer 7 can be converted to DC voltage without a switching operation of the switching elements 15a and 15b. However, the loss due to forward voltage of a diode is generally larger than the loss due to on-resistance of a switching element. Then, it is desirable that the switching elements 15a and 15b should be operated in synchronization with the operation of the input-side switching elements 5a and 5b.

The polarity in operation of the switching elements 15a and 15b differs depending upon a winding direction of the winding of the high frequency transformer 7. When the primary-side and secondary-side windings are wound so as to have different polarities as in the embodiment, the current flowing into the secondary-side winding 7S has a waveform phase-reversed relative to the current flowing into the primary-side winding 7P. Accordingly, the secondary-side switching elements 15a and 15b are switched by a drive signal with a polarity phase-reversed relative to the switching pattern of the primary-side switching elements 5a and 5b.

Accordingly, a drive signal to be supplied from the switching element drive circuit 23 to the switching element 5a is also supplied via an isolation circuit 24 to the gate of the switching element 15b. Furthermore, a drive signal to be supplied to the switching element 5b is also supplied via the isolation circuit 24 to the gate of the switching element 15a. FIG. 2-G shows the waveform of current IL2 flowing into the secondary-side winding 7S of the high frequency transformer 7. The waveform as shown in FIG. 2-G is reversed in phase relative to the current IL1 as shown in FIG. 2-F. Since the current IL2 presents a waveform changing in a sinusoidal waveform, the current IL2 is rectified by a smoothing unit such as the smoothing capacitor 14, so that the resonating operation is maintained and an output voltage is generated (FIG. 2-H). The smoothed DC output voltage is applied to the load 13. When the load 13 is a secondary battery, the battery is charged.

According to the above-described DC-DC converter 1, the smoothing capacitors 4 and 13, the switching circuits 5 and 15 and the capacitor circuits 6 and 16 are provided at the primary side and the secondary side of the high frequency transformer 7 respectively. When the midpoint voltage VC of the capacitor circuit 6 is detected by the voltage detection section 21, the drive signal generation circuit 22 generates a timing signal according to the switching operation of the switching circuit 5 based on the variation in the midpoint voltage VC, supplying the generated timing signal to the switching element drive circuit 23. The generated timing signal is synchronized with the period in which the winding voltage of the high frequency transformer 7 changes. Consequently, the resonance phenomenon is maintained irrespective of load variation and the DC-DC converter 1 can be operated at a maximum efficiency.

Furthermore, the voltage detection section 21, the drive signal generation circuit 22 and the switching element drive circuit 23 are provided only at the primary side of the high frequency transformer 7. The drive signal generated and supplied by the switching element drive circuit 23 is also supplied via the isolation circuit 24 to the secondary-side switching circuit 15, with the result that the configuration of the DC-DC converter 1 can be rendered simpler.

FIG. 3 illustrates a second embodiment. Identical or similar parts in the second embodiment are labeled by the same reference symbols as those in the first embodiment, and the description of these parts are eliminated. Only the difference between the first and second embodiments will be described. The DC-DC converter 31 according to the second embodiment includes the voltage detection section 21P, the drive signal generation circuit 22P and the switching element drive circuit 23P corresponding to the voltage detection section 21, the drive signal generation circuit 22 and the switching element drive circuit 23 in the first embodiment respectively. A voltage detection section 21S, a drive signal generation circuit 22S and a switching element drive circuit 23S are arranged at the secondary side so as to be symmetrical to the voltage detection section 21P, the drive signal generation circuit 22P and the switching element drive circuit 23P respectively. The isolation circuit 24 is eliminated.

The voltage detection section 21S detects a midpoint voltage between the capacitors 16a and 16b. The drive signal generation circuit 22S generates a timing signal. The switching element drive circuit 23S generates and supplies a drive signal to the gates of the switching elements 15a and 15b. Thus, the circuits having the same arrangement are provide at the primary and secondary sides respectively and are operated independently of each other. Accordingly, the second embodiment can achieve the same advantageous effect as the first embodiment.

FIGS. 4 to 6 illustrate a third embodiment. Only the differences between the first and third embodiments will be described. The DC-DC converter 41 according to the third embodiment is provided with a power regulating circuit 42 at the secondary side of the high frequency transformer 7. The voltage detection section 21 and the drive signal generation circuit 22 are shown more concretely in FIG. 4. Furthermore, a dead time generation circuit 43 is shown in FIG. 4 although it is not shown in the first embodiment. A part of the circuit is not shown in FIG. 4.

The voltage detection section 21 is composed of a series circuit of two resistance elements 44 and 45. The midpoint voltage VC is divided by the resistance elements 44 and 45. A series circuit of resistance elements 46 to 48 is connected in parallel to a series circuit of the capacitor 6a and 6b. A series circuit of resistance elements 49 and 50 is connected between the ground and a common connection point of the resistance elements 46 and 47. A series circuit of resistance elements 51 and 52 is connected between the ground and a common connection point of the resistance elements 47 and 48.

The drive signal generation circuit 22 includes two comparators 53a and 53b. Two common connection points of the resistance elements 44 and 45 are connected to an inverting input terminal of the comparator 53a and a non-inverting input terminal of the comparator 53b respectively. A common connection point of the resistance elements 49 and 50 is connected to an inverting input terminal of the comparator 53b. A common connection point of the resistance elements 51 and 52 is connected to a non-inverting input terminal of the comparator 53a. The comparator 53a has an output terminal connected via a Schmitt-trigger inverter 54a to one of two input terminals of a NAND gate 55a. The comparator 53b also has an output terminal connected via a Schmitt-trigger inverter 54b to one of two input terminals of a NAND gate 55b. The other input terminals of the NAND gates 55a and 55b are connected to output terminals of the NAND gates 55b and 55a respectively.

The output terminal of the NAND gate 55a is connected to one of two input terminals of an AND gate 71 composing the dead-time generation circuit 43. The AND gate 71 has an output terminal connected to one of two input terminals of an AND gate 56a. The output terminal of the NAND gate 55b is connected to one of two input terminals of an AND gate 56b. The aforesaid one input terminal of the AND gate 56a is connected via a series circuit of the resistance elements 57a and 58a to the ground. The aforesaid one input terminal of the AND gate 56b is also connected via a series circuit of the resistance elements 57b and 58b to the ground. A diode 59a is connected in inverse parallel to two ends of the resistance element 57a, and a diode 59b is also connected in inverse parallel to two ends of the resistance elements 57b. The AND gate 56a has the other input terminal connected to a common connection point of the resistance element 57a and the capacitor 58a, and the AND gate 56b also has the other input terminal connected to a common connection point of the resistance element 57b and the capacitor 58b.

The AND gate 56a has an output terminal connected via one of two input terminals of an OR gate 60a to an input terminal of the switching element drive circuit 23a. The AND gate 56b also has an output terminal connected via one of two input terminals of an OR gate 60b to an input terminal of the switching element drive circuit 23b. The OR gates 60a and 60b have the other input terminals connected to different output terminals of a micro-control unit (MCU) 61 and further connected to pull-down resistors 62a and 62b, respectively. The OR gates 60a and 60b have output terminals which are also connected to pull-down resistors 63a and 63b respectively.

The power regulating circuit 42 includes a series circuit of resistance elements 64 and 65 and a series circuit of a resistance element 66 and a Zener diode 67, both of which circuits are connected in parallel to each other between both ends of the secondary-side capacitor 14. A comparator 68 has an inverting input terminal connected to a common connection point of the resistance elements 64 and 65. The comparator 68 also has a non-inverting input terminal connected to a common connection point of the resistance element 66 and the Zener diode 67. The comparator 68 further has an output terminal connected to a pull-up resistor 69 and further to the other input terminal of the AND gate 71. An isolation circuit 70 has an output terminal connected to an input terminal of the MCU 61.

The operation of the third embodiment will now be described with reference to FIGS. 5 and 6 as well as FIG. 4. A resonant DC-DC converter generally has a difficulty in regulation of its output power since the resonant DC-DC converter is driven by a resonant operation under an optimum condition. Furthermore, since an output voltage is determined by a turn ratio of the high frequency transformer 7, the secondary-side output voltage cannot be regulated according to a load condition. In view of these circumstances, the DC-DC converter 41 according to the third embodiment includes the power regulating circuit 42 to provide higher efficiency.

Output voltage Vₒᵤₜ is obtained from input voltage Vᵢₙ and a turn ratio (N2/N1) of the high frequency transformer 7 and can be calculated by equation, Vₒᵤₜ=Vᵢₙ×(N2/N1). Furthermore, output power is obtained as product of the output voltage Vₒᵤₜ and output current. The output current is obtained by a difference between output voltage Vₒᵤₜ and voltage based on power stored in load 13 and dividing the difference by equivalent series resistance of the load 13 in the case where the load 13 includes a lithium-ion cell, a solar cell or the like.

The load 13 sometimes includes an inverter, a converter or the like. Accordingly, power stored in the load 13 is sometimes subjected to variation, and the DC-DC converter 41 requires an operation according to desired power. For example, voltage fluctuation in the load 13 is small when power of a circuit connected to the load 13 is small. In this case, even when the operation of the DC-DC converter 41 is instantaneously stopped, there is almost no influence on the power stored in the load 13. Accordingly, the output power can be regulated by starting and stopping the operation of the DC-DC converter 41 based on the voltage of the load 13.

The comparators 53a and 53b of the drive signal generation circuit 22 compare the midpoint voltage VC of the capacitors 6a and 6b with a lower potential-side threshold VL and a higher potential-side threshold VH respectively. The drive signal generation circuit 22 delivers the results of comparison via the inverters 54a and 54b to the NAND gates 55a and 55b respectively. The comparator 53a turns the signal to the high level when (divided) VC>VH, and the comparator 53b turns the signal to the high level when VC<VL.

The power regulating circuit 42 supplies a high level signal to the AND gate 71 when the divided secondary-side voltage of the high frequency transformer 7 is equal to or lower than a Zener voltage of the Zener diode 67. Accordingly, when output signals of the comparators 53a and 53b are turned to the high level, the output signals of the NAND gates 55a and 55b are turned to the high level.

In the dead-time circuit 43, rise of input signals of the AND gates 56a and 56b is delayed by the series circuits of the resistance elements 57a and 57b and the capacitors 58a and 58b respectively, with the result that dead time is provided. On the other hand, decay of the aforesaid input signals is rendered steeper by the action of the diodes 59a and 59b. Output signals of the NAND gates 56a and 56b are supplied via the OR gates 60a and 60b to the switching element drive circuits 23a and 23b respectively.

The power regulating circuit 42 changes the output signal of the comparator 68 to the low level (stop signal) when the secondary-side output voltage of the DC-DC converter 41 exceeds the reference voltage (the Zener voltage). Output of a gate drive signal at the switching element 5a side is prevented by the AND gate 71 (a logic circuit). In this case, the midpoint voltage VC of the capacitors 6a and 6b slowly decays finally to V−, as shown in FIG. 5-A. At the switching element 5b side, drive on the basis of the midpoint voltage VC continues for a while, but the drive signal at the switching element 5a side is stopped when voltage of the capacitor 6b is discharged (a power regulating period).

Accordingly, when the switching operation at the switching element 5a side is stopped, the input and output currents IL1 and IL2 decrease based on the inductance of the high frequency transformer 7 and the capacities of the capacitors 6 and 16 while the resonance is maintained. The power conversion operation is stopped when the output current IL2 is rendered zero (see FIGS. 5-D and 5-E).

Furthermore, after the output voltage of the DC-DC converter 41 exceeds the reference voltage and the switching operation is stopped, the voltage of the load 13 drops according to power consumed by a subsequent circuit connected to the load 13, or the like. As a result, when the output voltage drops below the reference voltage, the comparator 68 changes the output signal to the high level (see FIGS. 6-C and 6-D)

At this time, in order that the DC-DC converter 41 may be returned from the power regulation period in which the resonating operation is stopped, the MCU 61 (the starting circuit) having received an output signal from the comparator 68 generates and supplies a drive signal to the switching element 5a side (see FIG. 6-A). As a result, the capacitor 6b is charged so that the switching operation is restarted by the switching elements 5a and 5b.

According to the third embodiment described above, the comparator 68 compares the voltage to be applied to the secondary-side load 13 with the reference voltage supplied as the Zener voltage from the Zener diode 67, thereby generating and supplying the stop signal when the load voltage exceeds the reference voltage. Upon output of the stop signal, the AND gate 71 prevents the timing signal from being supplied from the drive signal generation circuit 22 to the switching element drive circuit 23a. Consequently, an excessive rise of output voltage of the DC-DC converter 41 can be prevented, with the result that the efficiency can be improved.

Furthermore, in order that the switching circuit 5 may start the switching operation under the condition that the switching operation is stopped, the MCU 61 generates and supplies a starting control signal to the drive circuit 23a, independently of the drive signal generation circuit 22. Consequently, the switching operation of the DC-DC converter 41 can be restarted after lapse of the power regulation period.

FIGS. 7 to 9 illustrate a fourth embodiment. Only the differences between the third and fourth embodiments will be described. The DC-DC converter 81 according to the fourth embodiment is provided with a starting circuit 82, instead of the MCU 61 in the third embodiment, as shown in FIG. 7. To the starting circuit 82 are supplied the voltage of the DC power source 3, the midpoint voltage VC and the output signal of the isolation circuit 70. A series circuit of resistance elements 83 and 84 is connected between the positive-side terminal of the DC power source 3 and the ground. A common connection point of the resistance elements 83 and 84 is connected to a non-inverting input terminal of a comparator 85.

A series circuit of resistance elements 86 and 87 is connected between a common connection point of the capacitors 6a and 6b and the ground. A common connection point of the resistance elements 86 and 87 is connected via a series circuit of a capacitor 88 and a resistance element 89 to a non-inverting input terminal 91 of an operational amplifier 90. The operational amplifier 90 has an inverting input terminal connected via a resistance element 91 to an output terminal thereof. In other words, the operational amplifier 90 constitutes a buffer circuit. The isolation circuit 70 has an output terminal connected to a non-inverting input terminal of a comparator 92. A reference voltage 93 is supplied to the inverting input terminals of the comparators 85 and 92 and a non-inverting input terminal of the operational amplifier 90.

The operational amplifier 90 has an output terminal connected to a non-inverting input terminal of a comparator 94. The comparator 94 has an inverting input terminal to which the reference voltage 93 is supplied. The comparator 94 has an output terminal connected via a NOT gate 95 to one of input terminals of a 3-input AND gate 96. The other two input terminals of the 3-input AND gate 96 are connected to output terminals 85 and 92 respectively.

FIG. 9A is a truth value table showing logic of the starting circuit 82. More specifically, the starting circuit 82 supplies a high-level signal to the OR gate 60a under the conditions that the signal supplied via the isolation circuit 70 is at high level (1) and accordingly, no power regulation is required, that the DC power source 3 is connected and that the midpoint voltage between the capacitors 6a and 6b is at V− level. As a result, the resonating operation of the DC-DC converter 81 is restarted after lapse of the power regulation period.

Furthermore, FIG. 9B is a truth value table showing logic of the OR gate 60a. In the case where the output signal of the starting circuit 82 is at low level (0), the output signal of the OR gate 60a is turned to low level since output of the signal from the drive signal generation circuit 22 is prevented as described in the third embodiment.

According to the fourth embodiment, since the DC-DC converter 81 is provided with the starting circuit 82 configured by hard logic, the fourth embodiment can achieve the same operation and advantageous effect as the third embodiment, without using the MCU 61.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A DC-DC converter comprising:
a primary-side smoothing capacitor connected in parallel to a primary-side DC power source;
a primary-side switching circuit including two series connected switching elements and connected in parallel to the DC power source;
a primary-side capacitor circuit including two series connected capacitors and connected in parallel to the DC power source;
a secondary-side smoothing capacitor connected in parallel to a secondary-side load;
a secondary-side switching circuit including two series connected switching elements and connected in parallel to the load;
a secondary-side capacitor circuit including two series connected capacitors and connected in parallel to the load;
a high frequency transformer including a primary-side winding connected to a common connection point of the primary-side switching circuit and a common connection point of the primary-side capacitor circuit, the high frequency transformer further including a secondary-side winding connected to a common connection point of the secondary-side switching circuit and a common connection point of the secondary-side capacitor circuit;
a voltage detection unit which is configured to detect a midpoint voltage of the primary-side or secondary-side capacitor circuit;
a drive circuit which is configured to supply a drive signal to the switching elements of the primary-side or secondary-side circuit;
a timing signal output unit which is configured to generate and supply to the drive circuit a timing signal according to a switching operation carried out by the primary-side or secondary-side switching circuit, the timing signal being in synchronization with a period in which a winding voltage of the high frequency transformer changes, the timing signal output unit generating the timing signal based on a change in the midpoint voltage.

2. The DC-DC converter according to claim 1, wherein the voltage detection unit, the timing signal output unit and the drive circuit are provided only in the primary side, and the drive signal generated by the drive circuit is supplied via an insulated circuit to the secondary-side switching circuit.

3. The DC-DC converter according to claim 1, wherein two voltage detection units, two timing signal output units and two drive circuits are individually provided at the primary and secondary sides respectively.

4. The DC-DC converter according to claim 1, further comprising:
a comparator which is configured to compare a voltage applied to the secondary-side load with a reference voltage, thereby generating and supplying a stop signal when the load voltage exceeds the reference voltage; and
a logic circuit which is configured to prevent input of the timing signal from the timing signal output unit to the drive circuit upon output of the stop signal.

5. The DC-DC converter according to claim 1, further comprising a starting circuit which is configured to generate and supply a starting control signal to the drive circuit independently of the timing signal output unit in order that the primary-side switching circuit may start a switching operation while stopping the switching operation.
